(19) United States
(12) Patent Application Publication
(10) Pub. No.: US 2008/0267496 A1
(43) Pub. Date: Oct. 30, 2008

(54) METHOD FOR CREATING AND PRESENTING A DYNAMIC MULTI-MEDIA VISUAL DISPLAY

(76) Inventors: Julian Siminski, Studio City, CA (US); Rob Wilson, Studio City, CA (US)

Correspondence Address: MARC E. HANKIN, ESQ., 11414 THURSTON CIRCLE, LOS ANGELES, CA, 90049, US

(21) Appl. No.: 11/740,866

(22) Filed: Apr. 26, 2007

(51) Int. Cl. G06K 9/36

(52) U.S. Cl. 382/167

(57) ABSTRACT

Various embodiments of this invention are directed toward a system and method for creating and displaying a dynamic multi-media visual display. In various embodiments of the invention, images are selected and digitally recorded. The images are then deconstructed and manipulated into a series of iterations. The iterations are then placed in a selected sequence and transitioned in an evolutionary manner from one to another in order to create the final sequence of images and the final dynamic multi-media visual display.

### FIELD OF INVENTION

Various embodiments of this invention relate, generally, to visual displays; more particularly, to systems and methods for creating and presenting a dynamic multi-media visual display.

### BACKGROUND

In the field of presenting visual art and visual displays, a variety of systems and methods are known for preparing and presenting visual displays in order to enhance spaces. Traditionally, for example, paintings and pictures are selected that enhance the mood of a space. The works are commonly selected to evoke desirable moods and utilize colors and textures that complement the surroundings.

Improvements on visual displays have been made throughout the development of moving pictures and slide shows. In the manner commonly known in the art, multiple images may be in sequence. In the field of slideshow art, for example, an artist configures multiple images to be played in sequence.

As technology has facilitated advances in visual displays, these advances have allowed artists to create dynamic multi-media displays. For example, television displays and projectors are commonly used in order to present a series of still images for visual display. These display systems replicate traditional photographic slide shows by allowing a series of photographs to be visually displayed. Furthermore, the images may be set to music in order to enhance the viewer's experience.

These technologies have facilitated improvements in visual displays by allowing dynamic displays to be presented or projected into spaces. High definition video technology has made it possible to more accurately depict the fine details of the subjects. There remains, however, a long felt need in the art for a system and method for acquiring, modifying, configuring, and displaying visual images in a manner that accurately reproduces the fine visual details of original tactile works of art in a digital format, is dynamic and configured to complement the surrounding space.

### SUMMARY OF THE INVENTION

Various embodiments of the invention disclose a system and method, which improves upon the prior art, by allowing creators of visual displays to acquire, modify, configure, and display images in a manner that accurately reproduces the fine visual details of original, tactile works of art in a digital format, introduces a dynamic or evolving dimension to these works, and thereby evokes desirable moods and complements surroundings according to the creator's programming.

The system and method disclosed by various embodiments of the invention comprises a system for creating evolving, dynamic artwork that accurately reproduces the fine visual details of original tactile works of art, and which is presented by a projector or commercial display. Various embodiments of the invention allow this accurate reproduction by utilizing high definition image acquisition and manipulation systems. Various embodiments of the invention improve upon prior art systems by allowing images to be manipulated in order to allow colors, hues, tones, and tempo of the artwork and the transition of the various images to be controlled by the creator. The system and method further allows users to customize the images to suit the surroundings by allowing the creator to tailor the image to the particular surroundings. In this manner, the invention improves upon prior art system by allowing the images to be combined in an evolutionary manner to create artwork that transitions over time through a sequence of related but subtly altered states, which can be tailored to the surroundings.

The system and method comprises a multi-media art display that is created as part of a multi-step process. The first step of the process comprises acquisition of the individual iterations. Iteration, as used throughout this patent, refers to an image that is recorded digitally and may be manipulated by any of the various imaging systems known in the art. The iterations are selected by the creator to suit the mood or surroundings of the space for which the art installation is designed. Upon selection, the iterations are recorded digitally, in a manner that allows them to be manipulated, duplicated, constructed, and deconstructed.

The second step of the process comprises configuring the images in order to suit the particular installation. The configuration step involves manipulating and customizing the images in order to match the particular surroundings. Furthermore, the images are configured in order to transition from one to another in a manner that is suitable to evoke the emotions and representations sought by the creator. The transitions are achieved by manipulating the images and making slight alterations to the iterations, such that they blend from one to another. Also, color calibration data is associated with the image at the time of capture, providing absolute reference points for primary colors (white, black, red, green, yellow and blue), ensuring that all phases of the creation process may be calibrated to replicate those colors from acquisition through display.

In several embodiments, images are initially constructed or deconstructed into a series of iterations, with each of the iterations including selected portions of the completed image. In various embodiments of the invention, the iterations feature individual colors or images, which, when combined, form the transitioning and complete image. Moreover, the coloring, hues, and textures of the iterations are modified in order to allow the smooth transitioning among the iterations.

After the manipulation of each iteration, the deconstructed iterations are reassembled and presented as iterations that transition from one to another, and upon the addition of the final iterations, the completed image sequence is presented. Additionally, the iterations may be duplicated and arranged in varying opaque or transparent layers. In this manner, a completed image slowly transitions over the course of time. The combined iterations evolve over time in the final visual display in order to form the original image, or a variation thereof.

During the configuration phase, the creator may further configure the images and iterations in order to modify their colors, hues, tones, and other such features in a manner in order to allow the images and iterations to better suit the space into which the art work is installed. Also, the iterations are arranged to transition in a smooth manner from one to another. Any of the various methods from transitioning from one image to another known in the art, such as gradually fading, morphing, and superimposing are used in order to create transitions among the images.

In creating the finalized work, a series of images, iterations and videos are combined in order to create the finalized work. The tempo and manner in which the images, iterations, and videos are transitioned allow further opportunity for the creator of the work to manipulate the emotions and sensations evoked by the work. Furthermore, the transition and pace of the images is configured at this stage in order to allow the desired mood, emotion, or effect. The pacing of the transitional effects may be adjusted such that, when the video files are played at a rate of 30-frames per second, the changes from one iteration to the next is barely discernable to the eye.

In a final stage of the process, the final dynamic multi-media visual display is presented. The final work is displayed using any of the various commercially available display systems known in the art. The display may be selected in order to match the space into which the work is installed. Displays, such as video projectors, High Definition Plasma, or LCD screens, and other such display types known within the art may be used within the principles of the invention.

In this manner, the system and method facilitates the creation of a dynamic multi-media visual display.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is an illustration of a series of variations of the hues, colors and textures, which are used in order to create the iterations, which comprise the final dynamic multi-media visual display.

FIG. 2 is an illustration that diagrams the manner in which the iterations are arranged over time in order to form a final dynamic multi-media visual display.

FIG. 3 is a flow chart that illustrates the process by which the final dynamic multi-media visual display is produced.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive. Also, the reference or non-reference to a particular embodiment of the invention should not be interpreted as a limit on the scope of the invention.

In the following description, certain terminology is used to describe certain features of one or more embodiments of the invention. For instance, “display” refers to any projection, cathode ray tube, LCD, plasma-screen, or other display type known in the art; “iteration” refers to any image or altered image, which may be altered by any of the various graphics production means known in the art. It should be noted that the final dynamic multi-media visual display may be projected onto any number of media types, including, fabric, fog, water, glass, walls, and other such media.

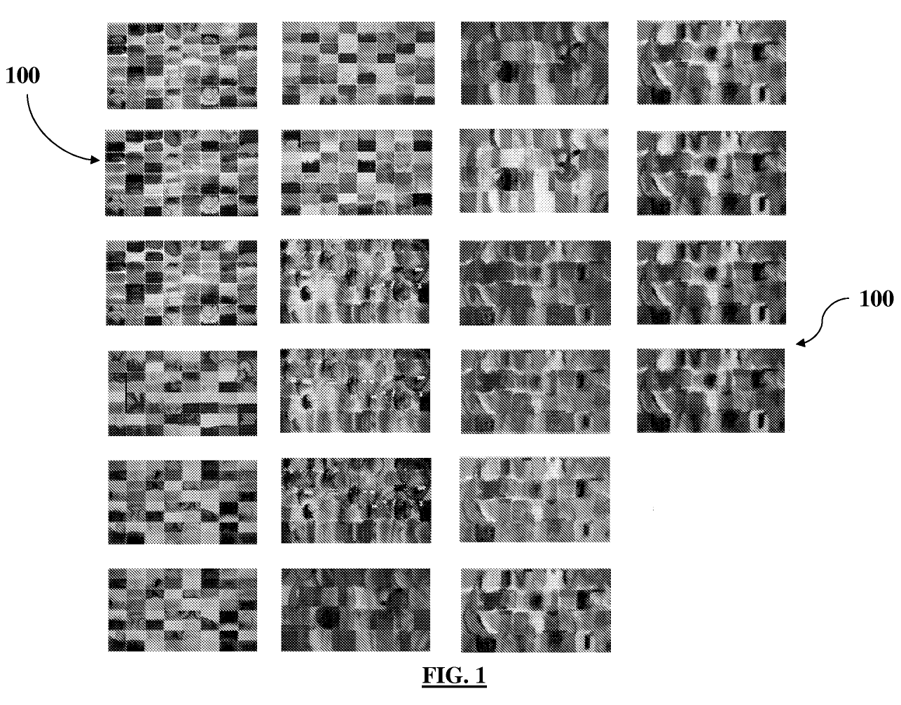

FIG. 1 is an illustration of a series of variations of the hues, colors and textures, which are used in order to create the iterations, which comprise the final dynamic multi-media visual display. FIG. 1 illustrates twenty-two iterations 100 of a completed work. The different frames illustrate the manner in which the colors and hues of the individual iterations are varied throughout the iteration preparation process. In this manner, because the transitions among the colors and shapes are performed in a subtle manner, the changes are barely noticed by the viewer. In various embodiments of the invention, the subtle changes occur at varying rates, elapsing between the 100% state of one image and the 100% state of the next.

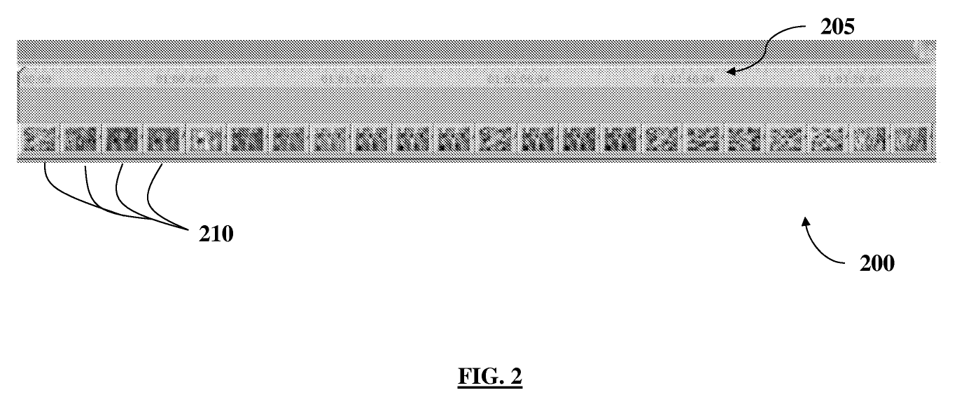

FIG. 2 is an illustration that diagrams the manner in which the iterations are arranged over time in order to form a final dynamic multi-media visual display. A time diagram 200 illustrates the manner in which the iterations 210 are arranged and manipulated over the timeline 205 of the presentation. As the iterations 210 are arranged over the timeline 205, the iterations 210 are enhanced by altering the colors and hues, adding transitional effects to the iterations, producing tonal shifts, and adding or overlapping other visual effects over the iterations 210. Also, at this stage of the production process, the time at which the iterations 210 shift from one another is determined according to the timeline 205.

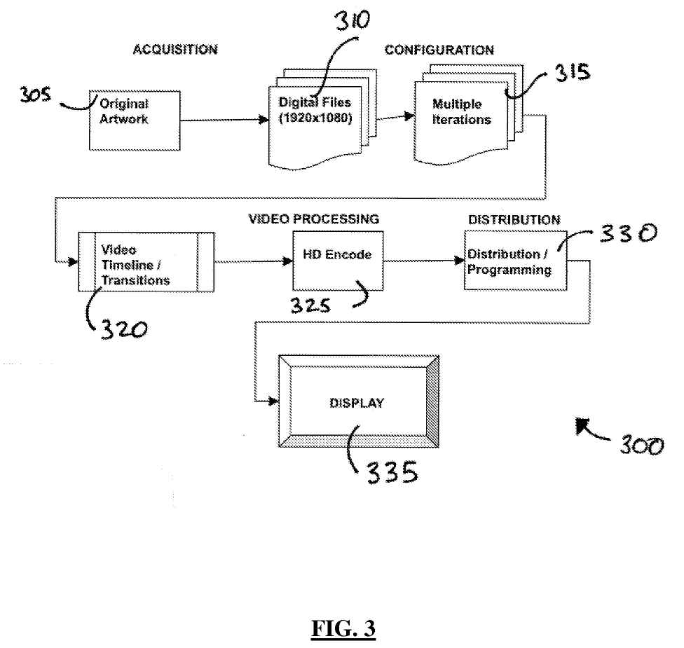

FIG. 3 is a flow chart that illustrates the process by which the final dynamic multi-media visual display is produced. The flow chart 300 illustrates the steps taken in order to produce a final work, including, the acquisition stage, wherein original artwork 305 is sought or produced. The original artwork 305 is then converted to digital files 310. From the digital files 310, multiple iterations are produced 315, which are deconstructions of the complete digital file. The deconstructed iterations 315 may consist of the image with particular colors removed, specific objects from the image, or other versions of a reduced version of the image. The iterations are then configured and manipulated by the creator of the final work 320. Colors, hues, textures, and other elements of the iterations, for example, may be manipulated, in order that the iteration may be blended to its neighboring iterations. During the deconstruction process, a photograph or illustration may be separated into its constituent colors, in the manner that silk screened images are separated into their colors. In this manner, when the images are allowed to overlap, the final image is progressively presented.

During this stage of the process, the images are further arranged in an order such that the iterations transition from one another. Furthermore, the creator of the dynamic multi-media visual display selects a transition pattern for the iterations to transition from one another, over time.

During the high definition or standard definition encoding process 325, the images are produced for high definition or standard definition visual presentation. Finally, the images are distributed 330 for display 335 utilizing one of the display systems known in the art.

In various embodiments of the invention, the dynamic multi-media visual display is configured to vary its display according to input received from the surrounding space. For example, the display may be configured to respond to inputs such as touch, radio frequency or infrared signals, computer programming, light intensity, movement, sound, or music. The display may respond to these inputs by altering the speed of transitions or images, altering the hues or colors of the images, adding or removing sound from the display, and further such alterations.

In further embodiments of the invention, the work can be programmed to interact with LED and other lighting systems, so that changes in the artwork trigger changes in the ambient space in which it is displayed. The display may be programmed to run at certain times of the day, or in a specific order.

It should be noted that the above diagram illustrates the general method in various embodiments of the invention. The principles of the invention may, however, be practiced with any number of variations on the basic principles of the invention. The iterations, for example, may undergo further manipulations in the configuration stage of the process. Also, different procedures may be applied to different images. Some images, for example, may be left unaltered. Also, the transitions among the images may take the form of any fading transitions known in the art.

What is claimed is:

1. A method for creating a dynamic multi-media visual display, comprising:
selecting a plurality of images,
recording said images digitally in a computer-based image storage device to form a plurality of digitally recorded images,
deconstructing said digitally recorded images into one or more iterations,
manipulating said iterations by altering the hue, color, texture, saturation, brightness, darkness, gamma, or color temperature of the iteration,
configuring the plurality of iterations to transition or overlap from one another in a selected order,
establishing the time for the plurality of iterations and the time for transitions among the selected iterations, and
displaying the plurality of iterations in sequence to form a dynamic multi-media visual display.

2. A method for creating a dynamic multi-media visual display according to claim 1, wherein said plurality of images comprise images selected from one or more of the following image types: photographs, digitally created images, hand drawn images, monotype and monoprint images, painted images, mixed-media images and lithographed images.

3. A method for creating a dynamic multi-media visual display according to claim 1, wherein said step of deconstructing said digitally recorded images into one or more iterations, comprises deconstructing said images according to the constituent colors of said images.

4. A method for creating a dynamic multi-media visual display according to claim 1, wherein the display is further configured to respond to an input, said input being selected from the following input types: touch, radio frequency, infrared signals, computer program, light intensity, movement, sound, and music.

5. A method for creating a dynamic multi-media visual display according to claim 4, wherein said display responds to said inputs by altering the speed of transitions or images, altering the hues or colors of the images, altering the sequence of the iterations, or adding or removing sound from the display.

6. A method for creating a dynamic multi-media visual display according to claim 1, wherein said multi-media visual display is further configured to interact with LED and other lighting systems, so that changes in the art work trigger changes in the lighting of the ambient space in which the dynamic multi-media visual display is presented.

7. A method for creating a dynamic multi-media visual display according to claim 1, wherein said step of manipulating said iterations by altering the hue, color, texture, saturation, brightness, darkness, gamma, or color temperature of the iteration, further comprises manipulating said iterations according to the surrounding space into which the final multi-media visual display will be presented.

8. A method for creating a dynamic multi-media visual display, comprising:
selecting a plurality of images, said plurality of images comprising images selected from one or more of the following image types:
photographs, digitally created images, hand drawn images, monotype prints, monoprint images, painted images, mixed-media images and lithographed images
recording said images digitally in a computer-based image storage device to form a plurality of digitally recorded images,
deconstructing said digitally recorded images into one or more iterations, the method of deconstructing images including deconstructing said images according to the constituent colors and shapes of said images,
manipulating said iterations by altering the hue, color, texture, saturation, brightness, darkness, gamma, or color temperature of the iteration,
configuring the plurality of iterations to transition or overlap from one to another in a selected order,
establishing the time for the plurality of iterations and the time for transitions among the selected iterations,
configuring the display of said images to respond to an input, said input being selected from the following input types: touch, radio frequency, computer program, infrared signals, light intensity, movement, sound, and music,
configuring said multi-media visual display to interact with LED and other lighting systems, so that changes in the art work trigger changes in the lighting of the ambient space in which the dynamic multi-media visual display is present, and
displaying the plurality of iterations in sequence to form a dynamic multi-media visual display.
